(19) United States
(12) Patent Application Publication
(10) Pub. No.: US 2012/0047988 A1
(43) Pub. Date: Mar. 1, 2012

(54) METHOD, APPARATUS AND SYSTEM FOR ACCURATELY MEASURING AND CALIBRATING LIQUID COMPONENTS DISPENSED FROM A DISPENSER

(75) Inventors: RICHARD JONDALL MEHUS, RICHFIELD, MN (US); JOHN THOMAS PELKEY, ST. PAUL, MN (US); RYAN JACOB URBAN, MAHTOMEDI, MN (US); QUANG VAN DAO, EDEN PRAIRIE, MN (US); SCOTT RUSSELL LIMBACK, ST. PAUL, MN (US)

(73) Assignee: ECOLAB USA INC, ST. PAUL, MN (US)

(21) Appl. No.: 12/862,990

(22) Filed: Aug. 25, 2010

(51) Int. Cl. G01F 25/00; B67D 7/16; B67D 7/00

(52) U.S. Cl. 73/1.36; 222/1; 222/71

(57) ABSTRACT

A method, apparatus and system provides for accurately measuring and calibrating liquid products dispensed from a dispenser. A liquid diluent enters an aspirator assembly (12). A liquid product is drawn from a product container through a flow meter (36) into the aspirator assembly (12), wherein liquid product and diluent are mixed to dispense at the outlet of the aspirator (14). The flow meter (36) monitors the amount of liquid product drawn into and dispensed from the aspirator (14).

### BACKGROUND OF THE INVENTION

1. Field of the Invention

This invention relates generally to a method, apparatus and system for accurately measuring and calibrating liquid components dispensed from a dispenser, and more particularly for accurately measuring and calibrating the dispensing of a liquid product.

2. Description of Prior Art

Many cleaning and sanitizing processes, whether laundering, warewashing or the like, have as a significant portion of their operating costs the expense of the formulated aqueous products they use. Furthermore, the effectiveness of most, if not all, cleaning and sanitizing processes is inextricably linked to supplying a calibrated or measured amount of a formulated aqueous product to the process. Too little product use can impair the effectiveness of a cleaning and/or sanitizing process. Too much product use can result in significant waste and adds unnecessary operating expenses to a business. For example, hospitality businesses such as hotels, hospitals, restaurants, and the like use liquid detergents and cleaning solutions for laundry and warewashing. These processes require proper formulation of the solutions to prevent waste and increase the effectiveness of the cleaning and sanitizing process. To achieve these objectives, many efforts have been made to calibrate, control and measure the dilution and delivery of concentrated liquid products. These processes vary from, on one hand, simply manually measuring and mixing to utilizing a computer-controlled dilution device. One common dilution mode involves utilizing a dispensing device that combines, under mixing conditions, a flow of concentrate and then a flow of diluent. The flow of liquid diluent can be directed through an aspirator such that, as the diluent passes through the aspirator, a negative pressure arises inside the aspirator drawing the liquid concentrate into the aspirator to mix with the liquid diluent. Both Copeland, et al., U.S. Pat. No. 5,033,649 and Freese, U.S. Pat. No. 4,817,825 and Mehus, et al., U.S. Pat. No. 5,915,592 disclose dispensers having aspirators for diluting liquid concentrates to produce liquid products in this general way. Such aspirator-type dispensers have been used for diluting and dispensing a liquid concentrate.

In a number of applications, there is a desire to supply a certain amount of liquid concentrate. In using a timing mechanism wherein the aqueous diluent is used for a certain amount of time, various amounts of concentrate may be dispensed depending upon the pressure of the liquid diluent and/or the viscosity of the liquid concentrate.

Given the range in viscosity of varying formulated liquid products, and the change that can result in viscosity due to the conditions uncontrollable by the manufacturer, such as temperature of the use location and pressure of the aqueous diluent used for dispensing, problems can and do occur that result in too little or too much product being dispensed. Even situations may arise where no product is dispensed as a result of the product source being empty or the dispenser malfunctioning without notice to an operator. There are numerous parameters and conditions that affect the dilution of liquid products that are dispensed by an aspirating dispenser.

The present invention addresses these problems and provides for a method, apparatus and system for accurately measuring and calibrating liquid components dispensed from a dispenser independent of the viscosity of the aqueous liquid product or the pressure of the source of the liquid diluent.

In addition, the present invention addresses the real-time monitoring of product dispensing, including the rate, volume and calibration of the product being dispensed to insure the liquid product is accurately measured and dispensed.

### BRIEF SUMMARY OF THE INVENTION

In one embodiment, the invention is a method for accurately measuring and calibrating liquid components dispensed from a dispenser. The method includes providing an aspirator having a plurality of liquid inlet ports and an outlet port so that each liquid inlet port receives a liquid component. A liquid component is passed through a flow meter and into the aspirator. An amount of the liquid component being introduced into the aspirator is measured with the flow meter, and the liquid component is dispensed from the outlet port of the aspirator.

In another embodiment, the invention is an apparatus for accurately measuring and calibrating liquid components dispensed from a dispenser. The apparatus has an aspirator having a plurality of liquid inlet ports and a liquid outlet port, whereby each liquid inlet port is in communication with a liquid source. A flow meter is connected in liquid communication to at least one of the liquid inlet ports. The flow meter includes an inlet connected to receive liquid from a liquid source and an outlet connected in liquid communication to a liquid inlet port of the aspirator. The flow meter is for measuring an amount of liquid being introduced into the aspirator from a liquid source. The flow meter is also connected in liquid communication to a liquid product source and the outlet is connected in liquid communication to a valve and to a liquid inlet port of the aspirator. The amount of liquid measured by the flow meter is the amount of liquid product aspirated into the aspirator from a liquid product source.

In another embodiment, the invention is a dispensing system for accurately measuring and calibrating dispensing of a liquid component. The system has an aspirator having a plurality of liquid inlet ports and an outlet port. Each liquid inlet port is for receiving a liquid component from a liquid source. A flow meter is connected in liquid communication to at least one of the liquid inlet ports in the aspirator to measure an amount of the liquid component being introduced into the aspirator. A valve is connected in liquid communication to a liquid source and a liquid inlet port of the aspirator. A controller is connected in electronic communication to the flow meter and the valve. The controller is configured to receive the measured amount from the flow meter and issue an instruction to the valve for actuating between open and closed positions based on the measured amount.

### BRIEF DESCRIPTION OF THE DRAWINGS

While the specification concludes with the claims particularly pointing out and distinctly claiming the invention, it is believed that the present invention will be better understood from the following description taken in conjunction with the accompanying drawings, in which:

FIG. 1 is a schematic representation of the present invention;

FIG. 2 is a cross-sectional view of the aspirator shown in FIG. 1;

FIG. 3 is a cross-sectional view of the flow meter shown in FIG. 1; and

FIG. 4 is a schematic representation of the present invention and incorporated into a commercial laundry system.

### DETAILED DESCRIPTION OF THE PREFERRED EMBODIMENTS

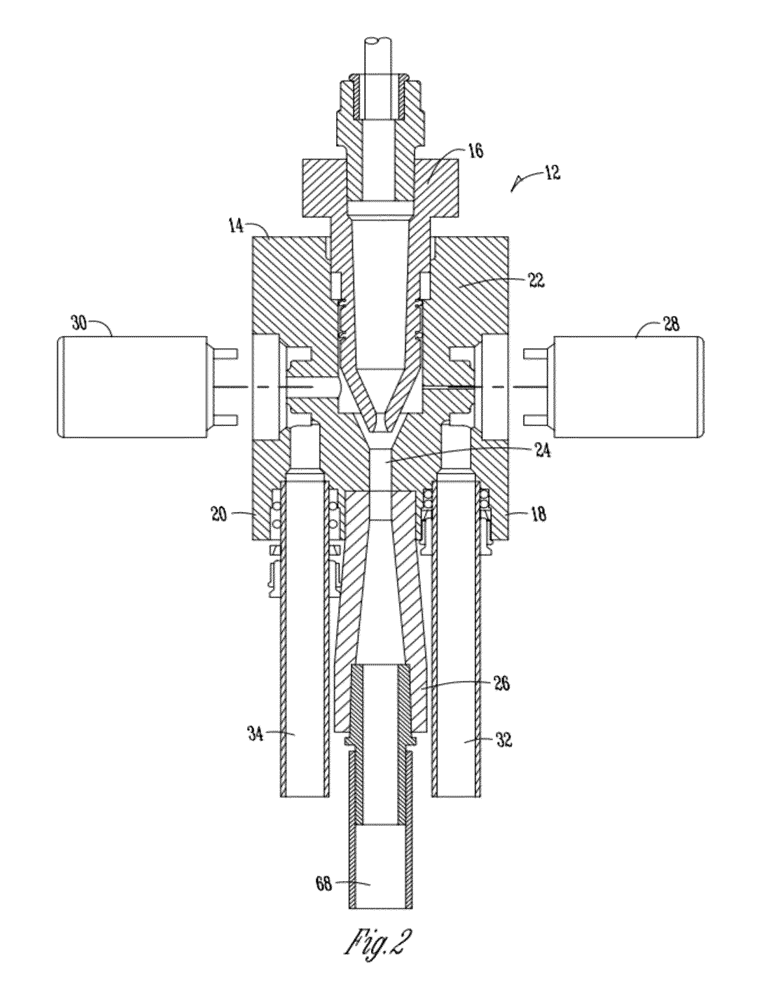

Referring to the drawings, wherein like numerals represent like parts throughout the several views, there is generally disclosed at 10 a dispensing apparatus. The dispensing apparatus 10 includes an aspirator assembly 12. The aspirator assembly 12 includes an aspirator and four solenoid valves 28-31 (solenoid valve 31 not shown). The aspirator also includes a diluent inlet port 16 in fluid communication with passageway 24 within the body 22 of aspirator 14 shown in FIG. 2. The aspirator also includes four product inlet ports 18-21 (product inlet ports 19 and 21 are not visible in FIG. 2). Passageway 24 within the aspirator body 22 is in fluid communication with outlet port 26. A similar multi-port aspirator is disclosed in application Ser. No. 11/206,618 entitled “Method and Apparatus for Dispensing a Use Solution” filed on Aug. 18, 2005 and is hereby incorporated by reference in its entirety.

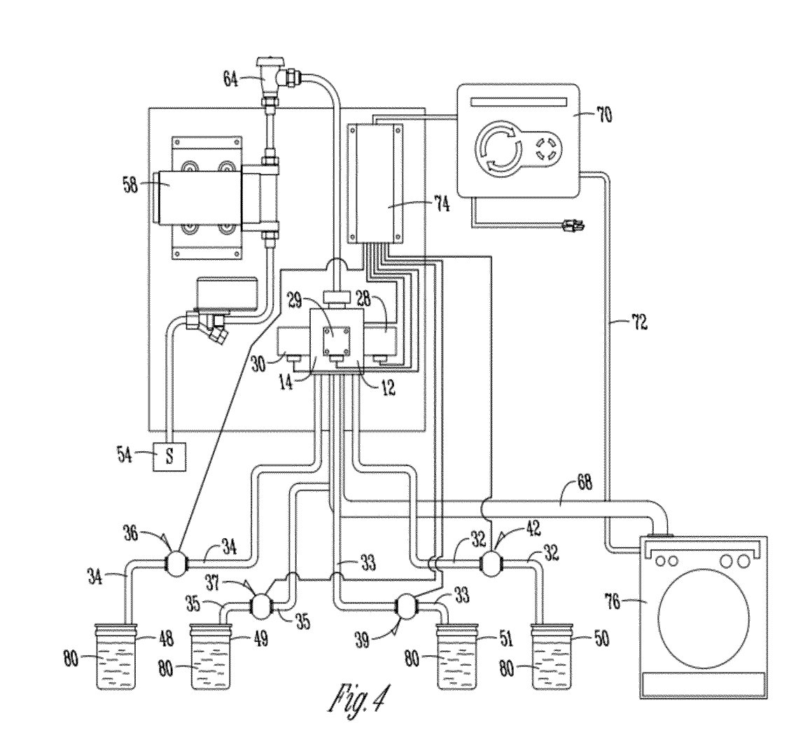

Each product inlet port 18-21 of aspirator 14 is connected in fluid communication to flow meters 36 and 42 (and two not shown) via a product conduit. The flow meter is in-turn connected in fluid communication to a product container 43 and 50 (and two not shown) via a product conduit. Product conduits 32-35 illustrated in FIG. 4 are connected in fluid communication to each of the product inlet ports of aspirator 14.

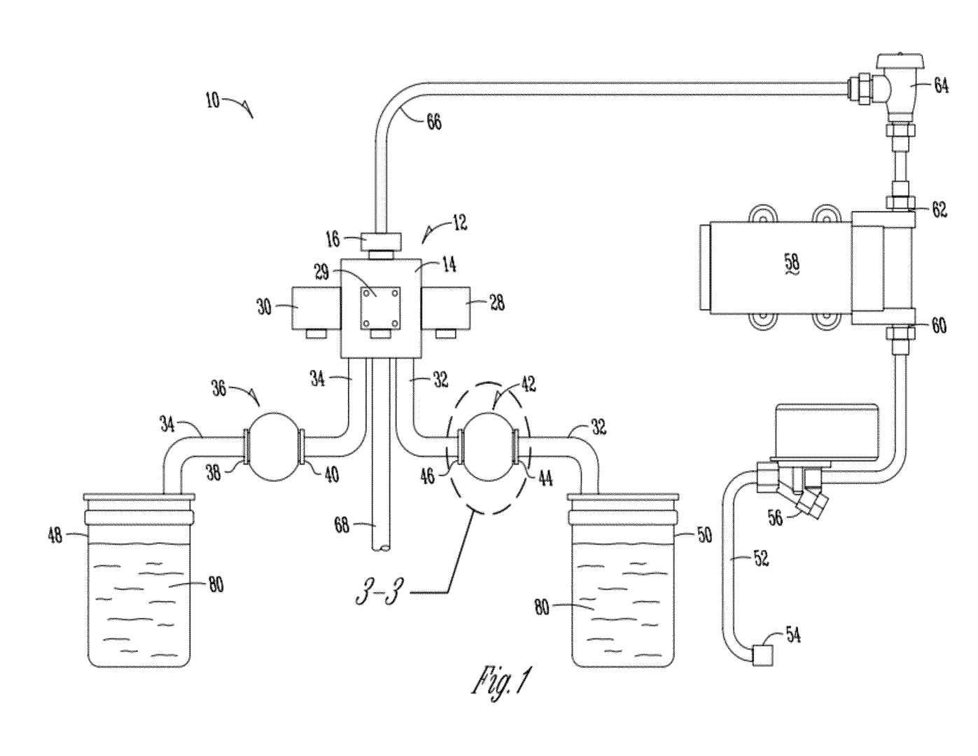

While the previously described dispensing assembly 10 is preferred to be used with the present invention, it is understood that other suitable assemblies may also be used in combination with the dispensing apparatus 10 of the present invention. Referring to FIG. 1, there is shown one embodiment utilizing one dispensing apparatus of the present invention. Water or other suitable diluents provided by a water or diluent source 54, is delivered under a source pressure by a suitable pressure to a water intake conduit 52. The source pressure is typically from 30 psi to 50 psi. A suitable water solenoid valve 56 is placed in the flow path of the intake conduit 52 and may be utilized to open and close the flow of the water through the intake conduit 52. The intake conduit 52 is connected in fluid communication to an inlet 60 of a boost pump 58. The boost pump 58 raises the pressure of the water or diluent from the source pressure to a suitable elevated pressure. The outlet 62 of the boost pump 58 is connected in fluid communication to the passageway 24 of aspirator 14 via a conduit 66 with an anti-siphon valve 64 positioned in the flow path of the conduit 66. The solenoid 56 is activated, at the appropriate time, to allow water or the diluent to flow at the source pressure to the boost pump where it is then elevated and enters the aspirator assembly 12.

Referring to FIG. 2, a cross-sectional view of the aspirator 14 of the present invention is shown. As previously indicated, the aspirator 14 includes a diluent inlet port 16 connected in liquid communication to the passageway 24 within the aspirator body 22. Product inlet ports 18-21 (and two not shown) are moved into fluid communication with passageway 24 within the aspirator body 22 by activation of solenoid valves 28-31 (and two not shown). The aspirator body 22 includes an outlet port 26 connected in fluid communication to the passageway 24. The aspirator 14 includes four product conduits 32-35 (and two not shown) operably connected to each of the product inlet ports 18-21. Further details and written description describing the various features, functions and structure of the aspirator assembly 12 are further described in application Ser. No. 11/206,618 incorporated by reference herein.

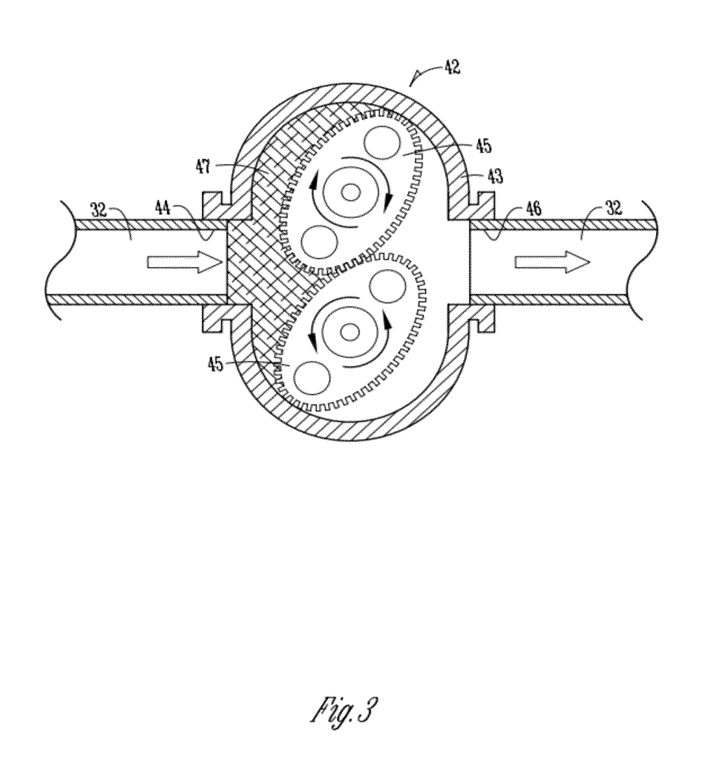

Referring to FIG. 3, a flow meter of the present invention is disclosed. The flow meter 42 includes a flow meter body 43 housing a pair of rotors 45 positioned between the inlet 44 and outlet 46. Within the flow meter body 43 and created between each rotor 45 are compartments 47 configured to trap a very precise volume of fluid between the outer oval shape of the rotor 45 and the inner chamber wall of the flow meter body 43. The flow meter 42 illustrated in FIG. 3 is of the oval gear meter type which is well known and commercially available. The oval gear flow meter 42 illustrated in FIG. 3 is a positive displacement flow meter. The flow meter operates by repeatedly filling and emptying compartments 47 of a known volume with a liquid. The flow rate is then calculated based on the number of times these compartments 47 are filled and emptied. The design of the oval gear flow meter 42, as previously described, allows the oval shaped gear-toothed rotors 45 to rotate within the flow meter body 43 having a specified geometry. As these rotors 45 turn, they sweep out and trap a very precise volume of fluid between the outer oval shape of the rotor 45 and the inner chamber walls with none of the fluid actually passing through the gear teeth. An oval gear meter is ideally suited for measurement of viscous fluids or those with varying viscosities. While the previously described flow meter 42 is preferred to be used with the present invention, it is understood that other suitable flow meters may also be utilized. Other potentially suitable types of flow meters include an orifice-square edge, orifice-conic edge, venturi, pilot tube, electromagnetic, turbine, ultrasonic-transit time, doppler, rotometer, vortex or coriolis flow meter.

In operation, a liquid, such a liquid diluent, is communicated from a liquid or diluent source 54 through intake conduit 52. A suitable water solenoid valve 56 is placed in the flow path of the intake conduit 52 and is utilized to open and close the flow of water through the intake conduit 52.

The boost pump 56 raises the pressure of the water from the source pressure from the pressure associated with source 54 to an elevated pressure. In one aspect of the invention the boost pump raises the pressure of liquid diluent from the source pressure to a suitable elevated pressure. Liquid diluent is communicated through the boost pump 56 through a conduit to an anti-siphon valve 64 such as an atmospheric pressure breaker which is commercially known and available. The diluent liquid is communicated from the anti-siphon valve 64 through conduit 66 into the aspirator assembly 12 by way of diluent inlet port 16. Then, by a suitable controller, not shown, one of the solenoid valves 28-31 is activated thereby placing the respective product inlet port 18-21 in communication with passageway 24 in aspirator body 22 illustrated in FIG. 2. By operation of an aspirator, which is well-known in the art, liquid product 80 such as a liquid concentrate, assuming a solenoid valve 28-31 is activated, will be drawn from the respective product containers 48-51 through product conduit 32-35. A flow meter is placed in the flow path of the product conduit 32-35 to ascertain an amount of the liquid product 80 being drawn from a product container. The liquid product 80 drawn from the product containers 48-51 is communicated through the flow meter and into the aspirator body 22. Liquid product 80 in product conduits 32-35, when a solenoid valve is actuated, is drawn into the aspirator body 22 and is dispensed, along with the liquid diluent, has a mixed solution.

Flow meters 36, 37, 39 and 42 continually monitor and calculate an amount, such as a volumetric amount, of the liquid product 80 being drawn from a product containers 48-51. In one aspect of the invention, a solenoid valve 28-31 is actuated so that the aspirator draws liquid product 80 from one of the liquid product containers 48-51 in through a flow meters 36, 37, 39 and 42. When the requested amount, such as the requested volume of liquid product, has been drawn into the aspirator 14, the solenoid valve 28-31 closes. The liquid product and liquid diluent are dispensed from the aspirator body 22 through outlet port 26 to the requesting end-use process via outlet conduit 68.

In the present invention, because flow meters 36, 37, 39 and 42 measure the volume of liquid product 80 being drawn into the aspirator 14, changes in the viscosity of the liquid product 80, pressure of the liquid diluent or other parameters related to aspirated dispensing do not affect the end volumetric amount that is dispensed through the aspirator. In the present invention, the source pressure or pressure of the liquid diluent entering the aspirator 14 may also vary. For example, the present invention contemplates a dispensing apparatus without a boost pump that operates using the source pressure of the liquid diluent from the source 54. Variations in the pressure of the liquid diluent passing through the aspirator 14 are compensated by the flow meters 36, 37, 39 and 42, which measures the exact volume of liquid product being dispensed regardless of changes in the pressure of the liquid diluent being used to draw the liquid product into the aspirator and dispense out the outlet port 26. For example, if the pressure of the liquid diluent passing through the aspirator 14 drops, the amount of liquid product 80 being drawn from a product container will also decrease, and thereby such dispensing cannot be time-based. With the present invention, a pressure drop in the liquid diluent source pressure does not result in a change in the end amount of liquid product being dispensed as the solenoid valve 28-31 is opened and closed according to information received from the flow meters 36, 37, 39 and 42. When the flow meters 36, 37, 39 and 42 indicate that the requested amount of liquid product has been dispensed, the flow meter then provides an instruction to a controller (not shown) which in turn closes the solenoid valve 28-31 to discontinue dispensing liquid product. In the case where the dispensing apparatus 10 malfunctions, such as where one of the flow meters malfunctions, the dispensing apparatus 10 may operate on a time-based dispensing process. This will allow the dispensing apparatus 10 to dispense at least some liquid product until the malfunction can be remedied.

The above-noted invention may be used for products that include softeners, neutralizers, starch, alkali, chlorine-bleach, or detergent.

Referring now to FIG. 4, there is shown a dispensing apparatus 10 incorporated into a commercial laundry system. The four product inlet ports 18-21 of aspirator 14 are connected in liquid communication to four product containers 48-51, via conduits 32-34, that contain the four liquid products to be dispensed. Flow meters 36, 37, 39 and 42 are placed in the flow path of conduits 32-34. A suitable controller 70 provides a low voltage connection to the solenoid valves 28-31 and flow meters 36, 37, 39 and 42 through an electrical connection 74. The controller 70 receives a signal via connection 72 to the laundry machine 76. The outlet conduit 68 of the aspirator 14 is connected in fluid communication to the laundry machine 76 to dispense a liquid product to the laundry machine 76. The laundry machine 76 sends a signal to controller 70. Based on the desired liquid product being requested by the laundry machine 76, an instruction is sent from the controller 70 through electrical connection 74 to actuate one of the solenoid valves 28-31. The requested liquid product 80 is drawn from a product containers 48-51 and through one of the flow meters 36, 37, 39 or 42 into the aspirator body 22 of aspirator 14. The liquid product and liquid diluent received from the liquid diluent source 54 is dispensed through outlet port 26 into the laundry machine 76 via outlet conduit 68. When the flow meters 36, 37, 39 or 42 detect that the requested amount of liquid product 80 has been dispensed from product containers 48-51, a signal is sent from the flow meter to controller 70 to actuate solenoid valve 28-31 to the closed position to discontinue dispensing of liquid product 80 to laundry machine 76. The controller 70 is able to continually monitor the amount, such as volumetric flow rate and amount of liquid product being drawn from a product containers 48-51 through the flow meters 36, 37, 39 and 42. Using this information, the controller is able to calibrate the precise amount of liquid product 80 being drawn from the product containers 48-51 into the aspirator 14, which is in turn dispensed for use in the laundry machine 76. In this manner, regardless of the viscosity of the liquid product or other dispensing parameters, the flow meters 36, 37, 39 and 42 are able to monitor the specific amount of liquid product 80 being dispensed and thereby send an instruction to the controller 70 to actuate solenoid valves 28-31 between open and closed positions for dispensing a precise amount of liquid product 80 to the laundry machine 76. The present invention thereby is capable of monitoring, in real-time, when the requested amount of liquid product has been drawn from the product container into the laundry machine 76. The controller 70 is able to start and stop dispensing based on information received from flow meters 36, 37, 39 and 42.

While the figures illustrate the use of flow meters 36, 37, 39 and 42 in the flow path of product conduits 32-35, it is understood that a flow meter may also be placed in the flow path of conduit 66 to measure the amount, such as the volumetric flow, of liquid diluent being introduced into the aspirator 14 from liquid diluent source 54. In this manner, dispensing apparatus 10 is able to monitor the specific amount of liquid diluent being introduced into the aspirator 14 and the specific amount of liquid product being drawn product containers thereby knowing the specific amount of both products being dispensed to the laundry machine 76. These or other suitable connections may be utilized to incorporate the dispensing apparatus 10 of the present invention into a dispensing system utilizing a use solution.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for accurately measuring and calibrating liquid components dispensed from dispenser, comprising:
providing an aspirator having a plurality of liquid inlet ports and an outlet port, each liquid inlet port for receiving a liquid component;
passing at least one liquid component through a flow meter and into the aspirator;
measuring an amount of the liquid component being introduced into the aspirator with the flow meter; and
dispensing the liquid component from the outlet port of the aspirator.

2. The method of claim 1 further comprising the step of calibrating in real-time the amount of the liquid component dispensed using the flow meter.

3. The method of claim 1 wherein the liquid component comprises a liquid product.

4. The method of claim 3 wherein the measuring step comprises measuring an amount of the liquid product being dispensed from the aspirator.

5. The method of claim 1 wherein the liquid component comprises a liquid diluent.

6. The method of claim 5 in combination with on-site formulator.

7. A method for accurately measuring and calibrating liquid components dispensed from a dispenser, comprising:
providing an aspirator having a diluent inlet port, a product inlet port and an outlet port;
introducing a liquid diluent into the aspirator through the diluent inlet port;
placing a liquid product in fluid communication with the product inlet port;
passing the liquid product through a flow meter and into the aspirator for preparing a mixed solution;
measuring an amount of the liquid product being dispensed with the flow meter; and
dispensing the mixed solution at the outlet.

8. A method of claim 7 wherein the step of placing a liquid product in fluid communication with the product inlet port comprises actuating a valve by instruction from a controller for passing liquid product through the flow meter into the aspirator.

9. A method of claim 8 further comprising the step of monitoring in real-time using the flow meter the amount of liquid product being dispensed for determining when to close the valve.

10. An apparatus for accurately measuring and calibrating liquid components dispensed from a dispenser, the apparatus comprising:
an aspirator having a plurality of liquid inlet ports and liquid outlet port, each liquid inlet port connected in communication with a liquid source;
a flow meter connected in liquid communication to at least one of the liquid inlet ports, the flow meter having:
a. an inlet connected to receive liquid from a liquid source.
b. an outlet connect liquid communication to a liquid inlet port of the aspirator; and
c. for measuring an amount of liquid being introduced into the aspirator from a liquid source.

11. The apparatus of claim 10 wherein the liquid inlet ports comprise:
a. a diluent inlet port for receiving a liquid diluent; and
b. a product inlet port for receiving a liquid product.

12. The apparatus of claim 10 wherein the inlet of the flow meter is connected in liquid communication to a liquid product source and the outlet is connected in liquid communication to a valve in fluid communication with a liquid inlet port of the aspirator.

13. The apparatus of claim 12 wherein the amount of liquid measured by the flow meter comprises an amount of liquid product aspirated into the aspirator from the liquid produce source.

14. An apparatus for accurately measuring and calibrating dispensing of a liquid product to form a solution, the apparatus comprising:
an aspirator having a diluent inlet port for receiving a stream of liquid diluent at an elevated pressure, at least one product inlet port for receiving a liquid product and an outlet port;
a flow meter having an inlet connected in liquid communication to a liquid product and an outlet connected in liquid communication to a product inlet port; and
the flow meter for measuring an amount of the liquid product being drawn into the aspirator for preparing a solution from the liquid product and liquid diluent for dispensing at the outlet port.

15. The apparatus of claim 14 further comprising a valve having an inlet connected in fluid communication to the flow meter and an outlet connected in fluid communication to a product inlet port of the aspirator.

16. The apparatus of claim 15 further comprising a controller connected in electronic communication to the flow meter and the valve, the controller configured to receive the amount of liquid product measured by the flow meter and issue an instruction to the valve for actuating between open and closed positions based on the measurement amount.

17. The apparatus of claim 14 in combination with a warewashing system.

18. The apparatus of claim 14 in combination with a laundry system.

19. A dispensing system for accurately measuring and calibrating dispensing of a liquid component, comprising:
an aspirator having a plurality of liquid inlet ports and an outlet port, each liquid inlet port for receiving a liquid component from a liquid source;
a flow meter connected in liquid communication to at least one of the liquid inlet ports of the aspirator to measure an amount of a liquid component introduced into the aspirator; and
a valve connected in liquid communication to a liquid source and liquid inlet port of the aspirator.

20. The dispensing system of claim 19 further comprising a controller connected in electronic communication to the flow meter and the valve, the controller configured to receive the measured amount from the flow meter and issue an instruction to the valve for actuating between open and closed positions based on the measurement amount.
